(19) United States
(12) Patent Application Publication
(10) Pub. No.: US 2019/0107179 A1
(43) Pub. Date: Apr. 11, 2019

(54) Friction Type One-Way High Damping Tensioner

(71) Applicant: ALT AMERICA INC., Westland, MI (US)

(72) Inventors: Wenhuan Wang, Westland, MI (US); Hao Xu, Jiangsu Province (CN)

(21) Appl. No.: 15/728,005

(22) Filed: Oct. 9, 2017

(51) Int. Cl. F16H 7/12; F16H 7/08

(52) U.S. Cl. CPC F16H 7/1209; F16H 7/0831; F16H 2007/084; F16H 7/1218; F16H 7/0848

(57) ABSTRACT

An engine timing tensioner including: a tensioner arm having a cylindrical protrusion extending from a first side of the tensioner arm; the cylindrical protrusion having at least one counter-bore disposed on a surface of the cylindrical protrusion and an inner bore extending through the cylindrical protrusion; an axle adapted to be received by the inner bore, the tensioner arm being adapted to rotate about the axle; a first spring disposed proximate a second side of the tensioner arm, opposite the first side, the first spring being adapted to bias the tensioner arm in a first direction; and a damping structure that includes a damping seat adapted to engage at least a portion of the axle; and a second spring, wherein a damping characteristic of the damping structure increased in responsive to the second spring limiting the tensioner arm in a second direction opposite the first direction.

### TECHNICAL FIELD

This disclosure relates to friction type one-way damping tensioners.

### BACKGROUND

A vehicle's engine having a large displacement are typically characterized as being fast and powerful and typically include an even number of cylinders (e.g., 4, 6, or 8 cylinders). However, vehicle manufacturers are increasingly designing vehicle engines having a relatively small displacement and may include an odd number of cylinders, such as 3 cylinders. By utilizing Fuel Stratified Injection (FSI) and Turbo Boost technologies, vehicle engines having a small displacement and an odd number of cylinders can achieve the same speed and power characteristics as typical large displacement engines having an even number of cylinders. Vehicle engines having an odd number of cylinders tend to create more undesirable characteristics, such as noise, vibration, and harshness (NVH) than vehicle engines having an even number of cylinders, due to the asymmetric characteristic of the moment of inertia generated by the vehicle having an odd number of cylinders while the vehicle engine is in operation. These undesirable characteristics may be exacerbated by the use of FSI and Turbo Boost technologies.

### SUMMARY

Disclosed herein are implementations of friction type one-way damping tensioners.

An aspect of the disclosed embodiments is an engine timing tensioner for reducing vibration and noise associated with an engine. The tensioner may include: a tensioner arm having a cylindrical protrusion extending from a first side of the tensioner arm, the cylindrical protrusion having at least one counter-bore disposed on a surface of the cylindrical protrusion and an inner bore extending through the cylindrical protrusion; an axle adapted to be received by the inner bore, the tensioner arm being adapted to rotate about the axle; a first spring disposed proximate a second side of the tensioner arm, opposite the first side, the first spring being adapted to bias the tensioner arm in a first direction; and a damping structure including: a damping seat adapted to engage a portion of the axle; and a second spring, wherein a damping characteristic of the damping structure increased in responsive to the second spring limiting the tensioner arm in a second direction opposite the first direction.

Another aspect of the disclosed embodiments is a tensioner that may include: a tensioner arm having a protrusion extending from a first side of the tensioner arm, the protrusion having an inner bore extending through the protrusion; an axle adapted to be received by the inner bore, the tensioner arm being adapted to rotate about the axle; a first spring disposed on an inner portion of the tensioner arm, the spring being adapted to bias the tensioner arm in a first direction; and a damping structure including: a damping seat adapted to engage a portion of the axle; and a second spring that includes: a first end disposed proximate the second side of the tensioner arm; and a second end coupled to the damping seat.

Another aspect of the disclosed embodiments is a system that may include: a tensioner arm having a cylindrical protrusion extending from a first side of the tensioner arm, the cylindrical protrusion having at least one counter-bore disposed on a surface of the cylindrical protrusion and inner bore extending through cylindrical protrusion; an axle adapted to be received by the inner bore, the tensioner arm being adapted to rotate about the axle; a first spring disposed proximate a second side of the tensioner arm, opposite the first side, the spring being adapted to bias the tensioner arm in a first direction; a friction pad that includes at least one boss having a profile corresponding to a profile of at least one counter-bore; a fixed bottom plate that includes a first spring seat hole disposed on an inner surface of the fixed bottom plate; and a damping structure that includes a damping seat adapted to engage at least a portion of the tensioner arm; a second spring that includes: a first end disposed proximate the second side of the tensioner arm; and a second end coupled to the damping seat; wherein the damping structure limits rotation of the tensioner arm in a second direction opposite the first direction.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 generally illustrates an example friction type one-way high damping tensioner according to the principles of the present disclosure.

FIGS. 2A-2B generally illustrates a fixed bottom plate according to the principles of the present disclosure.

FIGS. 3A-3B generally illustrate a tensioner arm according to the principles of the present disclosure.

FIG. 4 generally illustrates a pulley including a bearing according to the principles of the present disclosure.

FIGS. 5A-5B generally illustrates a friction pad according to the principles of the present disclosure.

FIG. 6 generally illustrates a self-lubricating bearing according to the principles of the present disclosure.

FIG. 7 generally illustrates a tensioner arm, a self-lubricating bearing, and a pulley according to the principles of the present disclosure.

FIGS. 8A-8B generally illustrates an axle according to the principles of the present disclosure.

FIG. 9 generally illustrates an axle and a fixed plate according to the principles of the present disclosure.

FIG. 10 generally illustrates a spring according to the principles of the present disclosure.

FIGS. 11A-11B generally illustrates an exploded view of a damping structure according to the principles of the present disclosure.

FIG. 12 generally illustrates an axle, a damping structure, and a fixed plate according to the principles of the present disclosure.

FIG. 13 generally illustrates a bushing according to the principles of the present disclosure.

FIG. 14 generally illustrates cover plate according to the principles of the present disclosure.

FIG. 15 generally illustrates an exploded view of a friction type one-way high damping tensioner according to the principles of the present disclosure.

### DETAILED DESCRIPTION

A vehicle engine, such as a spark ignition internal combustion engine can include a gasoline engine, a diesel engine, a hybrid engine, or other suitable spark ignition internal combustion engine. The vehicle engine includes an engine timing system adapted to control ignition timing such that spark, which ignites fuel compressed by a piston in a combustion chamber, will occur in the combustion chamber near the end of a compression stroke of the piston in the combustion chamber. Controlling ignition timing can affect the performance of the vehicle engine and can improve the fuel efficiency of the vehicle engine. For example, excessive vibration and/or noise can occur when the spark occurs too soon or too late relative to the compression stroke of the piston. Further, the vehicle engine can be damaged when the ignition timing is improperly controlled. As customer expectations continue to increase, there is a strong need to reduce the vibration and noise perceived by the customer. Typically, vibration and noise perceived by the customer can be reduced by having an engine timing system that includes a timing belt tensioner that includes a damping structure.

Timing belt tensioners that include a damping structure typically have low damping characteristics. Further, a typical timing belt tensioner may not reduce vibration quickly and may not effectively absorb energy generated by the vibration. Additionally, or alternatively, a typical timing belt tensioner having relatively high damping characteristics may be too large in size to fit in compacted engines like three-cylinder engines and V-6 engines. Accordingly, a friction type one-way high damping tensioner may be desirable.

In some embodiments, an engine timing system can include a friction type one-way high damping tensioner according to the principles of the present disclosure. The friction type one-way high damping tensioner can be adapted to allow a relatively large friction force to be generated when a tensioner arm associated with the engine timing system is rotated in a first direction and can allow a relatively small frictional force to be generated when the tensioner arm is rotated in a second direction opposite the first direction. The friction type one-way high damping tensioner can be adapted to provide a friction brake which may effectively inhibit and/or reduce timing belt jitter, vibration, noise, or combination thereof that can result from tension arm swing.

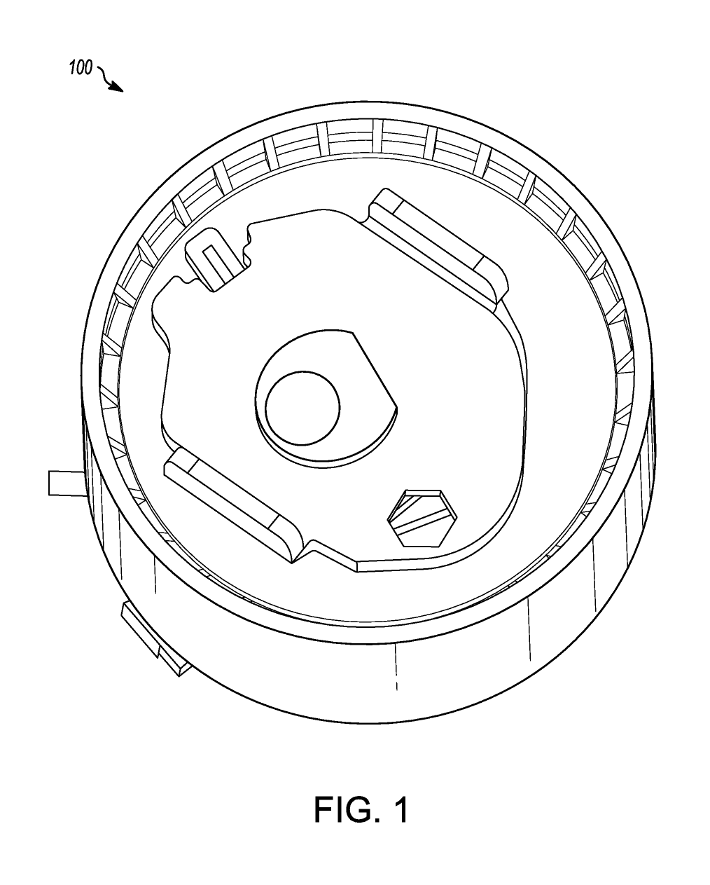

FIG. 1 generally illustrates an example friction type one-way high damping tensioner 100 (“tensioner 100”) according to the principles of the present disclosure. The tensioner 100 can be associated with a vehicle engine, such as a spark ignition internal combustion engine having an odd number of cylinders, such as three cylinders, or an even number of cylinders, such as six cylinders, as described above. The tensioner 100 is adapted to control ignition timing of the vehicle engine. Additionally, or alternatively, the tensioner 100 is adapted to reduce, inhibit, and/or eliminate vibration and/or noise associated with a timing belt and/or other components of the vehicle engine.

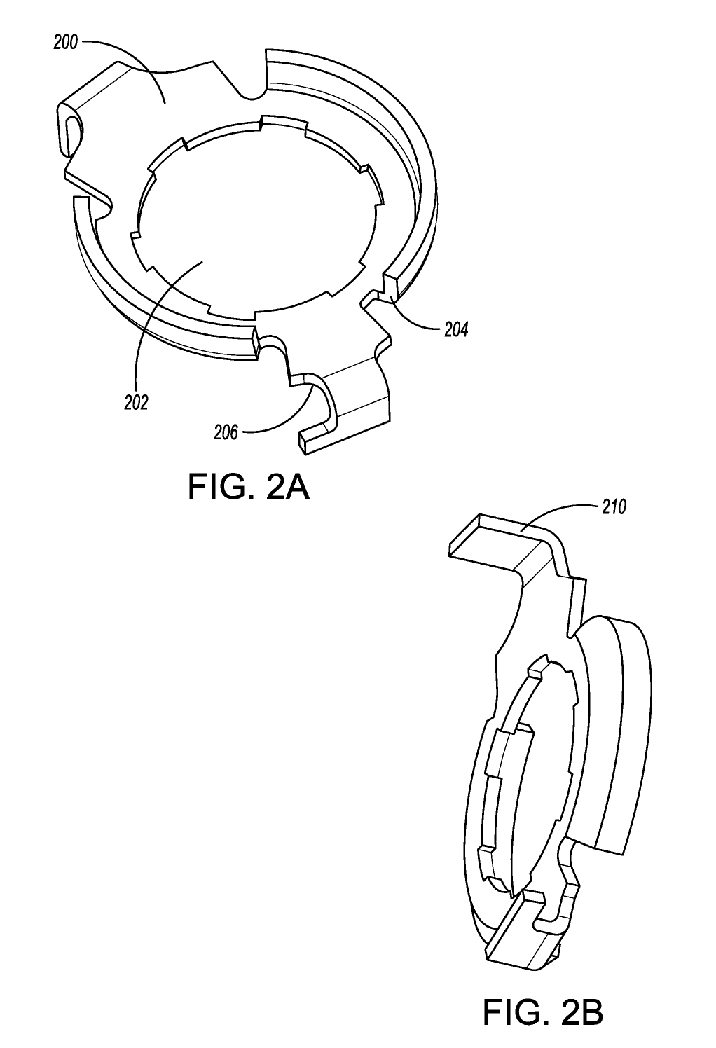

In some embodiments, the tensioner 100 includes a fixed bottom plate 200, as is generally illustrated in FIGS. 2A-2B. The fixed bottom plate 200 includes a center hole 202 and a stopper 204. The stopper 204 is adapted to cooperate with a portion of the vehicle engine to limit rotation in a circumferential direction of the fixed bottom plate 200 relatives to the vehicle engine. In some embodiments, the fixed bottom plate includes a spring seat hole 206 and a stopper 210.

In some embodiments, the center hole 202 includes 6 points round riveting drilled holes, disposed near the center hole 202 on a surface of the bottom plate 200.

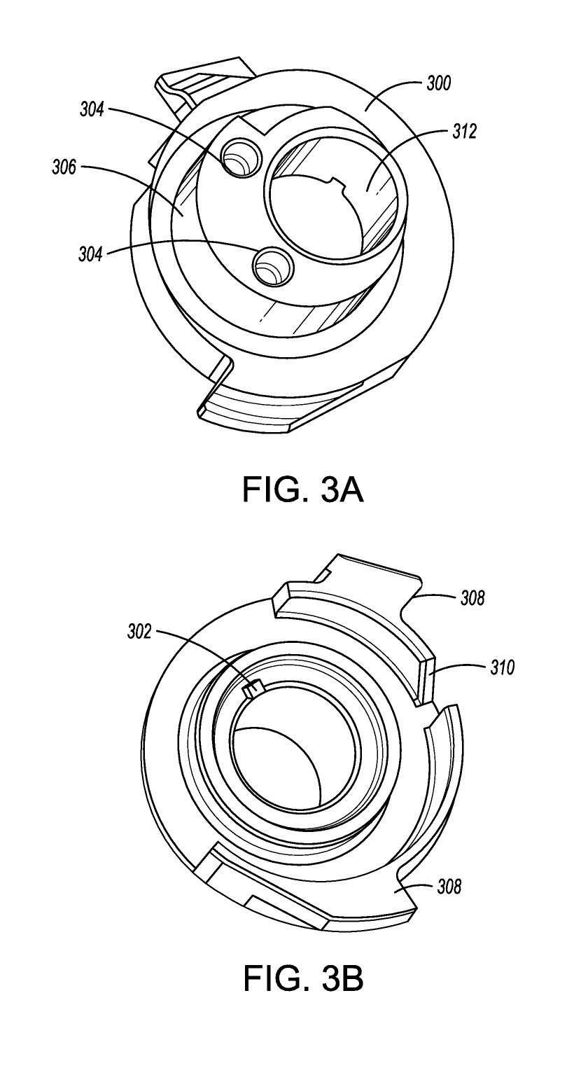

The tensioner 100 includes a tensioner arm 300, as is generally illustrated in FIGS. 3A-3B. The tensioner arm 300 includes a first spring seat hole 302, one or more counter-bores 304, a second spring seat hole 310, and an inner bore 312. In some embodiments, the one or more counter-bores 304 are disposed on a first side of the tensioner arm 300, the first spring seat hole 302 and the second spring seat hole 310 are disposed on a second side of the tensioner arm.

In some embodiments, the inner bore 312 is adapted to pass through the tensioner arm 300 and is at least partially defined by a cylindrical protrusion 306 having a generally cylindrical profile that extends from the tensioner arm 300. In some embodiments, the tensioner arm 300 is adapted to rotate about the inner bore 312. In some embodiments, the tensioner arm 300 includes a stopper 308. The stopper 308 is adapted to limit the working range of the stopper 210 of the fixed bottom plate 200. For example, the two ends of the stopper 308 cooperatively operate to restrain the stopper 210.

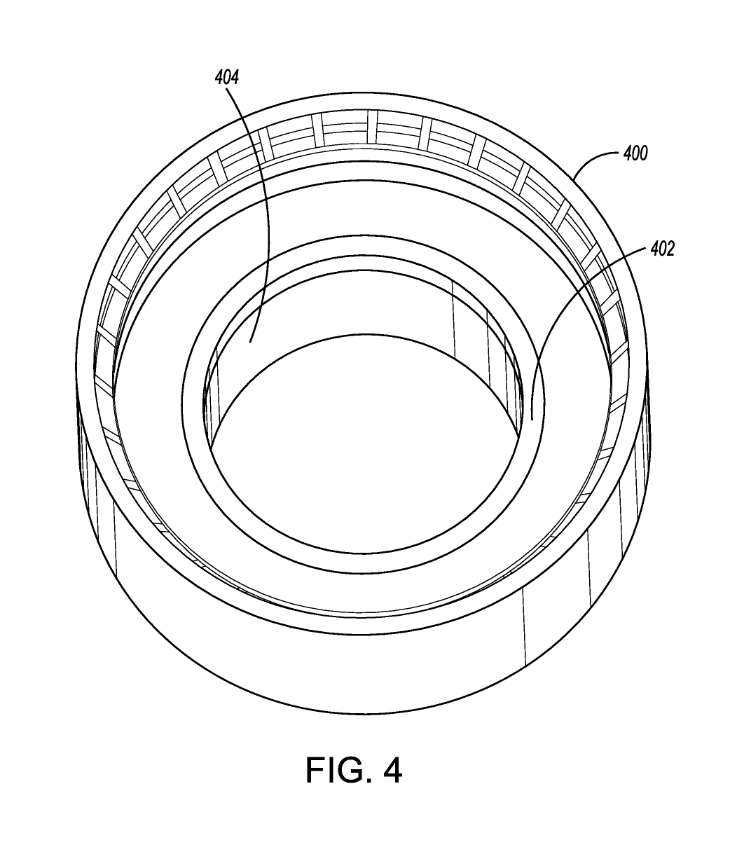

The tensioner 100 includes a pulley 400, as is generally illustrated in FIG. 4. The pulley 400 includes a bearing 402 where the bearing 402 includes an inner bore 404. The inner bore 404 is adapted to receive the cylindrical protrusion 306.

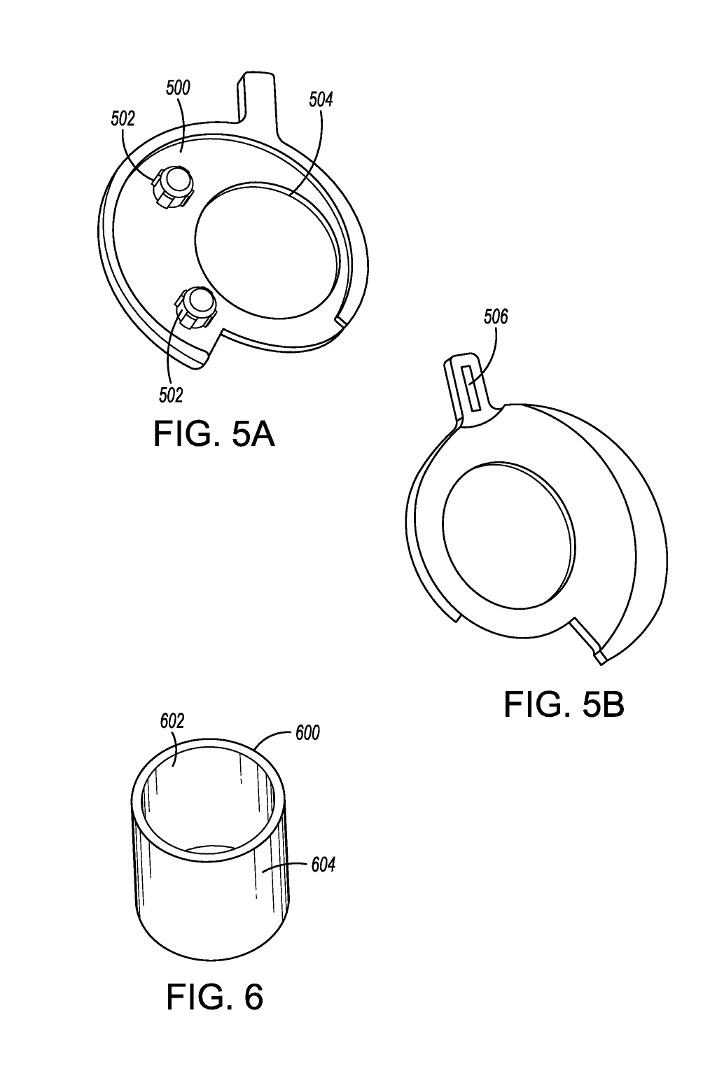

The tensioner 100 includes a friction pad 500, as is generally illustrated in FIGS. 5A-5B. The friction pad 500 includes one or more bosses 502. The one or more bosses are disposed on a surface of the friction pad 500. The one or more bosses 502 extend away from the surface of the friction pad 500. The one or more bosses 502 include a generally cylindrical profile and are adapted to be received by corresponding counter-bores 304 of the tensioner arm 300. The tensioner arm includes a through bore 504. The through bore 504 extends through the friction pad 500 and is disposed proximate the one or more bosses 502. The friction pad 500 includes a pin hole 506 disposed on the outer surface of the friction pad 500.

The tensioner 100 includes a self-lubricating bearing 600, as is generally illustrated in FIG. 6. The self-lubricating bearing includes a generally cylindrical profile. The self-lubricating bearing 600 can be a conventional self-lubricating bearing or other suitable self-lubricating bearing. The self-lubricating bearing 600 includes an inner bore 602 and an outer profile 604. The outer profile 604 defines an outer surface of the self-lubricating bearing 600.

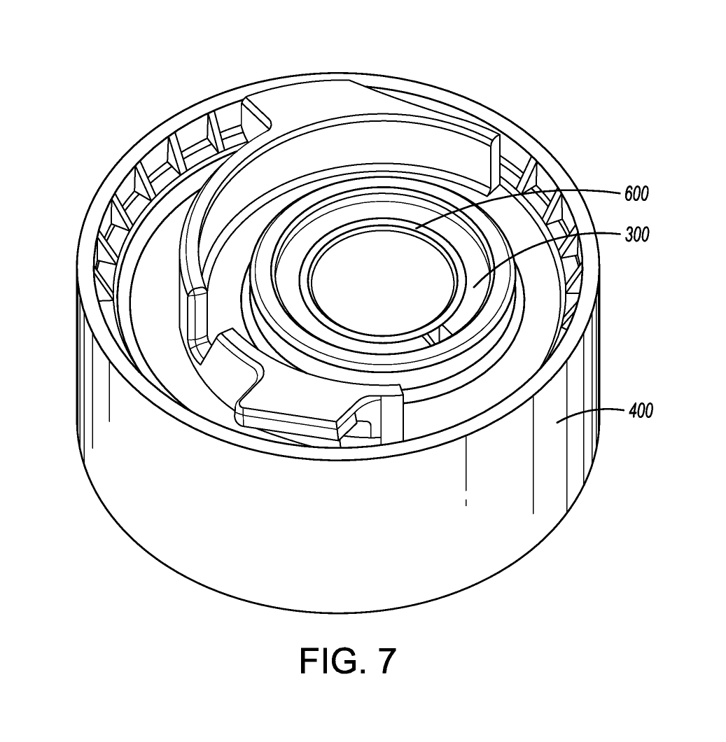

In some embodiments, the self-lubricating bearing 600 is adapted to be received by the inner bore 312 of the tensioner arm 300. For example, the self-lubricating bearing 600 can be press fit into the inner bore 312, as is generally illustrated in FIG. 7.

In some embodiments, the bearing 402 of the pulley 400 can be adapted to receive the tensioner arm 300. For example, the inner bore 404 of the bearing 402 includes a profile corresponding to a portion of the cylindrical protrusion 306 of the tensioner arm 300. The cylindrical protrusion 306 can be press fit into the inner bore 404.

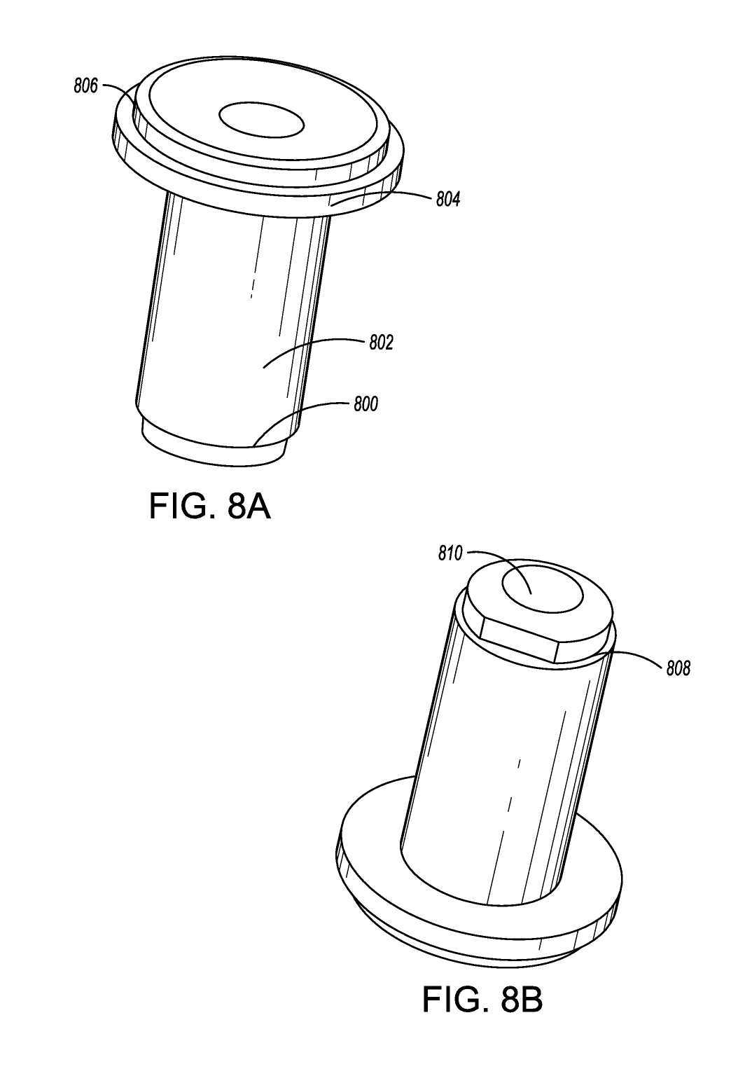

The tensioner 100 includes an axle 800, as is generally illustrated in FIGS. 8A-8B. The axle 800 includes a first outer profile 802, a second outer profile 806 on the outer surface of a first end of axle 800, and a third outer profile 808. The first outer profile 802 of the axle 800 is adapted to be received by the inner bore 602 of the self-lubricating bearing 600. The third outer profile 808 can include a partial cylindrical profile and is adapted to fix the axle 800 to the cover plate 1400.

The axle 800 includes a bolt mounting hole 810 disposed on a second end of the axle 800 opposite the first end. The bolt mounting hole 810 can be eccentric to the axle 800. The axle 800 includes a stopper 804 disposed on a second end of the axle 800 opposite to the bolt mounting hole 810.

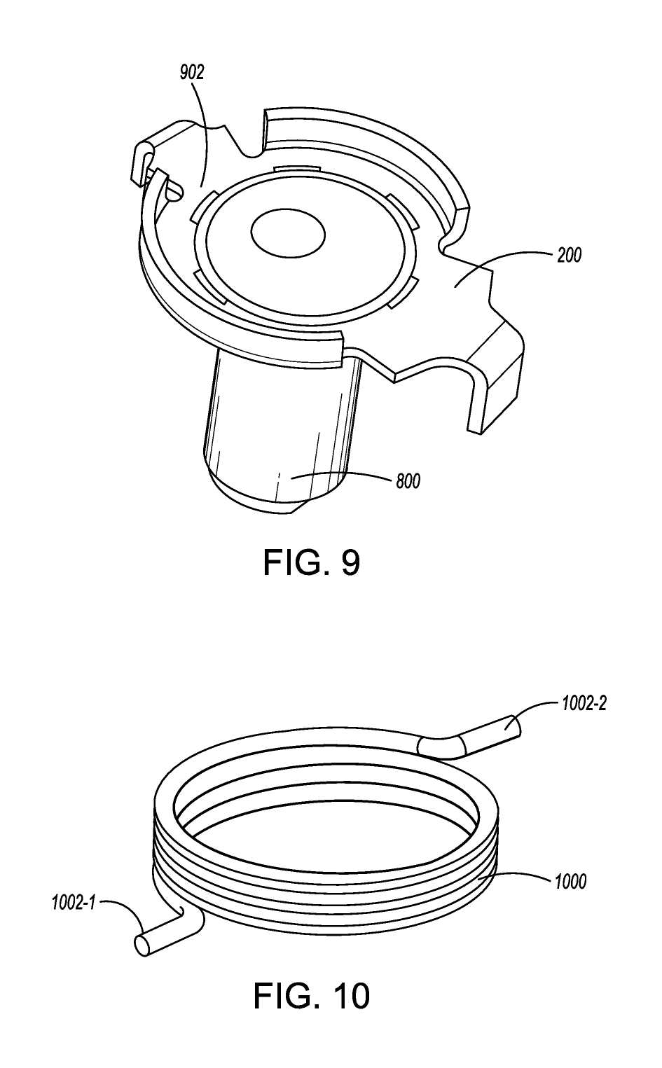

In some embodiments, the second outer profile 806 is adapted to be received by the center hole 202 of the fixed bottom plate 200. For example, the second outer profile 806 can be clearance fit into the center hole 202, and can be connected to the fixed bottom plate 200 by placing rivets into the 6 points round riveting drilled holes, as is generally illustrated in FIG. 9.

In some embodiments, the tensioner 100 includes a spring 1000, as is generally illustrated in FIG. 10. The spring 1000 includes a first end 1002-1 and a second end 1002-2. In some embodiments, the first end 1002-1 is adapted to be received by the spring seat hole 206 of the fixed bottom plate 200 and the second end 1002-2 is adapted to be received by the second spring seat hole 310 of the tensioner arm 300.

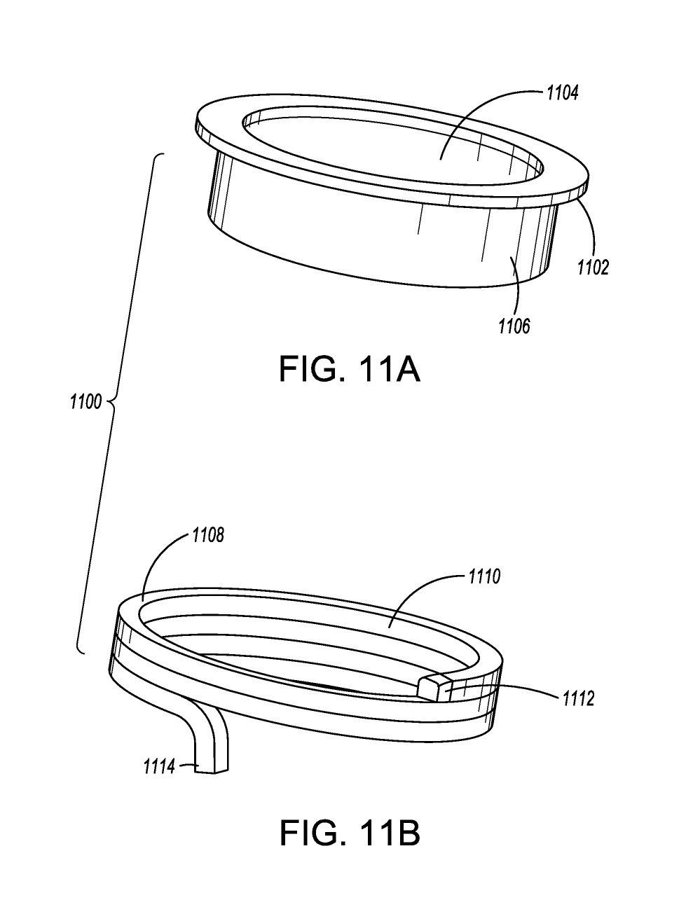

In some embodiments, the tensioner 10 includes a damping structure 1100, as is generally illustrated in FIGS. 11A-11B. The damping structure 1100 is adapted to reduce, inhibit, and/or eliminate vibration, and noise associated with a timing belt and/or other components of the vehicle engine. The damping structure 1100 includes a damping seat 1102 and a spring 1108 coiled clockwise to the damping seat 1102. In some embodiments, the damping seat 1102 includes an inner bore 1104 and an outer profile 1106. The spring 1108 has a first end 1112, an extension 1114, and an inner bore 1110.

The first end 1112 of the spring 1108 is adapted to be coiled clockwise to the outer profile 1106 of the damping seat 1102. For example, a diameter of inner bore 1110 is slightly smaller than a diameter of the outer profile 1106 of the damping seat 1102, such that, the outer profile 1106 of the damping seat 1102 tightly engages the inner bore 1110 of the spring 1108.

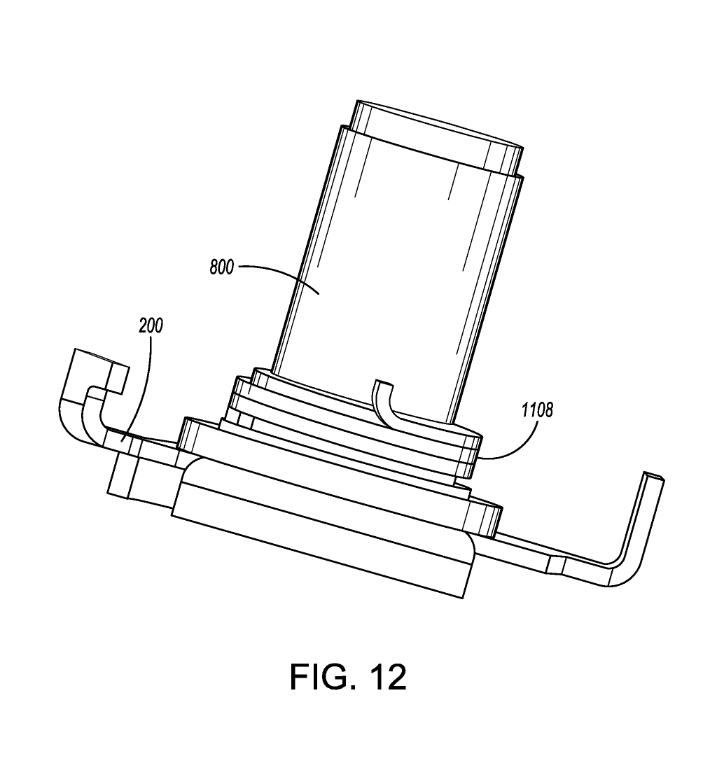

In some embodiments, the inner bore 1104 of the damping seat 1102 is adapted to receive the first outer profile 802 of the axle 800, and the second outer profile 806 of the axle 800 is adapted to be received by the fixed bottom plate 200, as is generally illustrated in FIG. 12. For example, the first outer profile 802 of the axle 800 can be press fit into the inner bore 1104 of the damping seat 1102 to fix the axle 800 to the damping seat 1102. The second outer profile 806 of the axle 800 can be a clearance fit into the center hole 202 of the fix bottom plate 200 and can be connected to the fixed bottom plate 200 by placing rivets into the 6 points round riveting drilled holes.

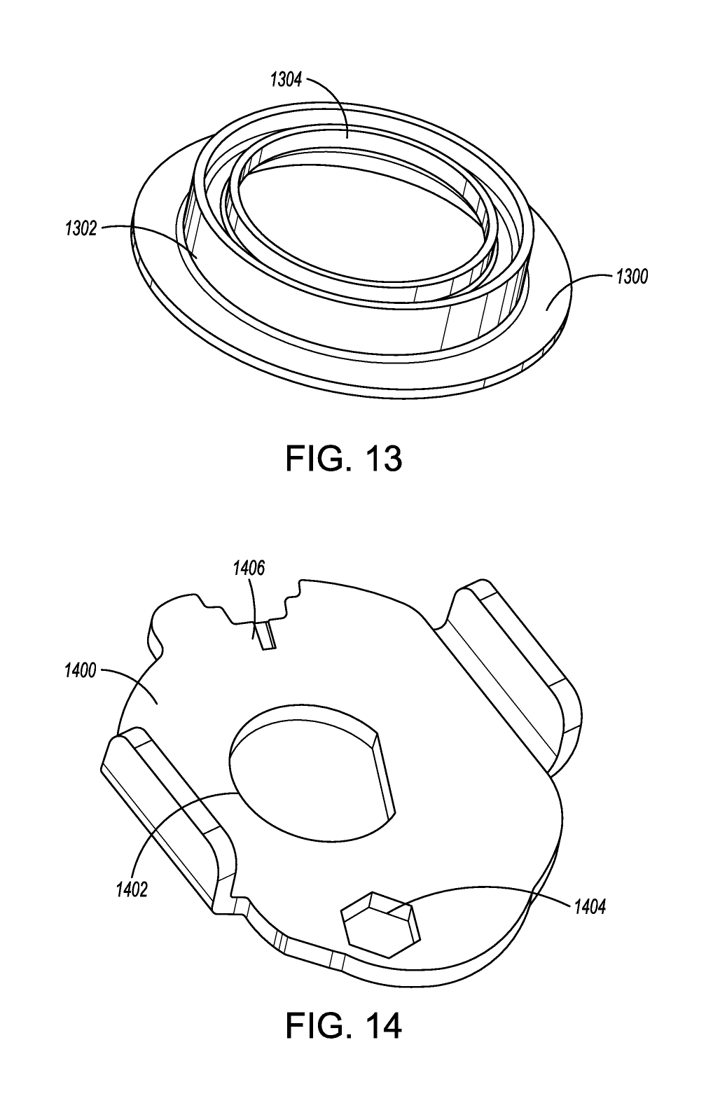

In some embodiments, the tensioner 100 includes a bushing 1300, as is generally illustrated in FIG. 13. The bushing 1300 includes an inner bore 1304 and an outer profile 1302 disposed on a first side of the bushing 1300. In some embodiments, the inner bore 1304 is adapted to receive the outer profile of the stopper 804 of the axle 800. A lower portion of the bushing 1300 which is disposed on a second side of the bushing 1300 opposite to the first side, is adjusted to make contact with a portion of the fixed bottom plate 200.

The tensioner 100 includes a cover plate 1400, as is generally illustrated in FIG. 14. In some embodiments, the cover plate 1400 includes a pin hole 1406, an inner bore 1402, and an adjusting aperture 1404 disposed on the surface of the cover plate 1400. In some embodiments, the inner bore 1402 is adapted to receive the third outer profile 808 of the axle 800. For example, the third outer profile 808 is adapted to be press fit into the inner bore 1402 to fix the cover plate 1400 to the axle 800. In some embodiments, the diameter of the third outer profile 808 is smaller than the diameter of the first outer profile 802, and the difference in profile diameters can prevent the axle 800 from passing beyond the cover plate 1400.

The adjusting aperture 1404 can be used to align the pin hole 1406 on a surface of the cover plate 1400, with the pin hole 506 on the outer surface of the friction pad 500. For example, the adjusting aperture 1404 can be a hexagon socket adjusting hole which can be adjusted using a wrench or another suitable device.

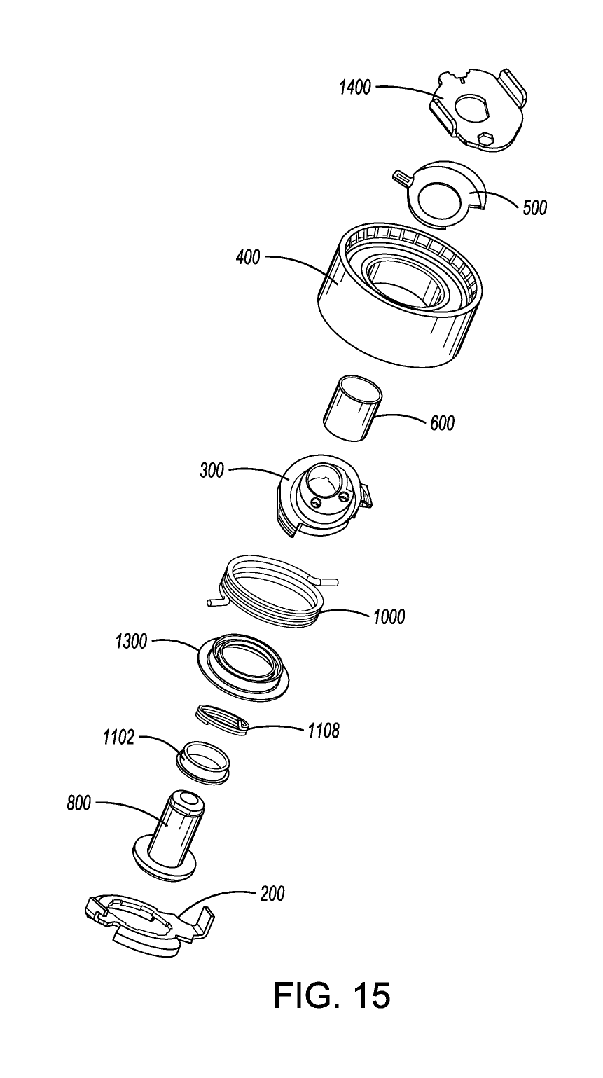

FIG. 15 generally illustrates an exploded view of the tensioner 100, including the fixed bottom plate 200, the axle 800, the damping structure that includes the damping seat 1102 and the spring 1108, the spring 1000, the tensioner arm 300, the self-lubricating bearing 600, the pulley 400, the friction pad 500, and the cover plate 1400.

As described above, the pulley 400 is adapted to receive the tensioner arm 300. In some embodiments, the self-lubricating bearing 600 is received by the inner bore 312 of the tensioner arm 300. The spring 1000 is adapted to be received by the tensioner arm 300. The friction pad 500 is adapted to be received by the tensioner arm 300. For example, as described above, the friction pad includes one or more bosses 502. The one or more bosses 502 are adapted to be received by corresponding counter-bores 304 of the tensioner arm 300, fit snug against the tensioner arm 300.

As described above, the axle 800 is adapted to be received by the inner bore 602 of the self-lubricating bearing 600. The axle 800 may be inserted through the inner bore 1104 of the damping seat 1102. The axle 800 may pass through the inner bore 1104 of the damping seat 1102 into the inner bore 602 of the self-lubricating bearing 600. As described above, the first outer profile 802 of the axle 800 is adapted to be press fit into the inner bore 1104, such that the first outer profile 802 fits snug within the inner bore 1104. In some embodiments, the stopper 804 of the axle 800 includes a profile adapted to prevent the axle 800 from passing through the inner bore 1104 beyond the damping seat 1102. For example, the stopper 804 includes a profile having a diameter that is larger than a diameter associated with the inner bore 1104, such that the stopper 804 cannot pass into and/or through the inner bore 1104. The stopper 804 is adapted to make contact with a portion of the damping seat 1102.

The tensioner arm 300 is adapted to rotate about the axle 800. For example, the first outer profile 802 of the axle 800 is intermeshed with the profile of the inner bore 602 of the self-lubricating bearing 600 when the axle 800 is received by the tensioner arm 300. The self-lubricating bearing 600 is adapted to allow the tensioner arm 300 to rotate about the axle 800.

In some embodiments, the damping structure 1100 is adapted to be received by the tensioner arm 300. For example, the second end of the spring 1108 includes an extension 1114. The extension 1114 is adapted to be received by the first spring seat hole 302 of the tensioner arm 300. For example, the extension 1114 includes a profile corresponding to a profile of the first spring seat hole 302. The extension 1114 is adapted to be press fit into the first spring seat hole 302.

In some embodiments, the cover plate 1400 is adapted to be secured to the friction pad 500. For example, the pin hole 1406 of the cover plate 1400 is adapted to align with the pin hole 506 of the friction pad 500 when the cover plate 1400 is received by the friction pad 500. In some embodiments, the relative position between the cover plate 1400 and the friction pad 500 can be adjusted using the adjusting aperture 1404. For example, the adjusting aperture 1404 can be a hexagon socket adjusting hole which can be adjusted using a wrench or another suitable device.

The friction pad 500 is adapted to generate a relatively large friction force when the tensioner arm 300 rotates about the axle 800 in a first direction. In some embodiments, the damping structure 1100 is adapted to generate a relatively small friction force when the tensioner arm 300 rotates about the axle 800 in a second direction opposite the first direction. Additionally, or alternatively, the damping structure 1100 is adapted to limit rotation of the tensioner arm 300 in the second direction. The damping structure 1100 may provide friction breaking to the tensioner arm 300 when the damping structure 1100 limits rotation of the tensioner arm 300 in the second direction.

For example, the spring 1000 is adapted to provide an initial torque on the tensioner arm 300. The spring 1000 may be adapted to bias the tensioner arm 300 in a starting and/or initial position. The force applied by the spring 1000 of the tensioner arm 300 may encourage the tensioner arm 300 to return to the starting and/or initial position when the tensioner arm 300 rotates about the axle 800.

In some embodiments, a timing belt may engage the tensioner 100 at a first end of the timing belt and one or more timing components of a vehicle engine at a second end of the timing belt. The one or more timing belt component may rotate in response to rotation of the vehicle engine. The one or more timing components may rotate the timing belt. The timing belt may cause the tensioner arm 300 to rotate about the axle 800. The damping structure 1100 limits rotation of the tensioner arm 300 in the direction of the rotation of the timing belt (e.g., the second direction) and provide vibration and noise reduction. Additionally, or alternatively, the spring 1000 may bias the tensioner arm 300, such that, vibration and noise generated from the tensioner 100, the timing belt, and/or the vehicle engine are reduced.

In some embodiments, the fixed bottom plate 200 may be fixed and/or secured to and an engine housing associated with the vehicle engine. When the pressure on the tensioner 100 increases, as the timing belt tension increases, the tensioner arm 300 will rotate in a clockwise direction. The pressure as a result of the contact between the extension 1114 of the spring 1108 and the first spring seat hole 302 disposed on the second side of the tensioner arm 300 releases, causing the spring 1108 to extend and rotate in the same direction as the rotation of the tensioner arm 300. The rotation of the spring 1108 is in the same direction as the direction which the spring 1108 is coiled to the damping seat 1102. The spring 1108 extends in length and is compressed against the damping seat 1102 which generates a sliding friction between the spring 1108 and the damping seat 1102 in the same direction as the direction of the torque provided by the spring 1000. The damping of the tensioner 100 generated by the clockwise rotation of the tensioner arm 300, is the sum of the torque provided by the spring 1000 and the sliding friction created by the spring 1108 and the damping seat 1102. Thus, the damping of the tensioner 100, as a result of the clockwise rotation of the tensioner arm 300, may quickly suppress and/or limit the swing of the timing belt with respect to the tensioner 100.

When the pressure on the tensioner 100 decreases, as the timing belt tension decreases, the tensioner arm 300 rotates in a counterclockwise direction. The tensioner arm 300 pushes the spring 1108 to rotate in the same direction as a result of the contact between the extension 1114 of the spring 1108 and the first spring seat hole 302 disposed on the second side of the tensioner arm 300. The rotation of the spring 1108 is in the opposite direction as the direction which the spring 1108 was coiled to the damping seat 1102. The spring 1108 is extended in coil diameter around the damping seat 1102 and generates a sliding friction between the spring 1108 and the damping seat 1102 in the opposite direction as the direction of the torque generated by the spring 1000. The damping of the tensioner 100, as a result of the counterclockwise rotation of the tensioner arm 300, is the sum of the torque provided by the spring 1000 minus the sliding friction created by the contact between the spring 1108 and the damping seat 1102. Thus, the damping of the tensioner 100, generated by the counterclockwise rotation of the tensioner arm 300 is smaller than the damping of the tensioner 100 generated by the clockwise rotation of the tensioner arm 300. Thus, when the tensioner tension decreases, the tensioner 100 may quickly tension the timing belt against a component of the vehicle engine.

In some embodiments, the tensioner arm may include a self-lubricating bearing disposed in the inner bore of the tension arm. The tensioner may include a friction pad that includes at least one boss having a profile corresponding to a profile of the at least one counter-bore. The first spring may include a first end and a second end. The first end may be received by a second spring seat hole disposed on the second side of the tensioner arm and the second end is received by a third spring seat hole disposed on an inner surface of the fixed bottom plate. The tensioner may include a pulley that includes a bearing. The bearing includes a through bore that is adapted to receive a portion of the tensioner arm. The tensioner may include a fixed bottom plate that includes a center hole that is adapted to receive at least a portion of the damping structure. The tensioner may include a cover plate that includes a first pin hole disposed on an outer surface of the fixed bottom plate and the friction pad includes a second pin hole disposed on an outer surface of the friction pad. The cover plate may include an adjusting aperture that can be used to align the first pin hole with the second pin hole.

In some embodiments, the tensioner may include a bushing that is compressed to the axle connecting with the fixed bottom plate. The damping structure may include a damping seat adapted to engage at least a portion of the axle and a second spring that includes a first end disposed proximate the second side of the tensioner arm and a second end coupled to the damping seat.

In some embodiments, an engine timing tensioner for reducing vibration and noise associated with a vehicle engine may include: a tensioner arm having a cylindrical protrusion extending from a first side of the tensioner arm; the cylindrical protrusion having at least one counter-bore disposed on a surface of the cylindrical protrusion and an inner bore extending through the cylindrical protrusion; an axle adapted to be received by the inner bore, the tensioner arm being adapted to rotate about the axle; a first spring disposed proximate a second side of the tensioner arm, opposite the first side, the first spring being adapted to bias the tensioner arm in a first direction; and a damping structure that includes a damping seat adapted to engage at least a portion of the axle; and a second spring, wherein a damping characteristic of the damping structure increased in responsive to the second spring limiting the tensioner arm in a second direction opposite the first direction.

In some embodiments, a tensioner comprising: a tensioner arm having a protrusion extending from a first side of the tensioner arm; the protrusion having an inner bore extending through the protrusion; an axle adapted to be received by the inner bore, the tensioner arm being adapted to rotate about the axle; a first spring disposed on an inner portion of the tensioner arm, the spring being adapted to bias the tensioner arm in a first direction; and a damping structure that includes a damping seat adapted to engage at least a portion of the axle; and a second spring that includes: a first end disposed proximate the second side of the tensioner arm; and a second end coupled to the damping seat.

In some embodiments, a system that may include: a tensioner arm having a cylindrical protrusion extending from a first side of the tensioner arm, the cylindrical protrusion having at least one counter-bore disposed on a surface of the cylindrical protrusion and inner bore extending through cylindrical protrusion; an axle adapted to be received by the inner bore, the tensioner arm being adapted to rotate about the axle; a first spring disposed proximate a second side of the tensioner arm, opposite the first side, the spring being adapted to bias the tensioner arm in a first direction; a friction pad that includes at least one boss having a profile corresponding to a profile of at least one counter-bore; a fixed bottom plate that includes a first spring seat hole disposed on an inner surface of the fixed bottom plate; and a damping structure that includes a damping seat adapted to engage at least a portion of the tensioner arm; a second spring that includes: a first end disposed proximate the second side of the tensioner arm; and a second end coupled to the damping seat; wherein the damping structure limits rotation of the tensioner arm in a second direction opposite the first direction.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

While the disclosure has been described in connection with certain embodiments or implementations, it is to be understood that the disclosure is not to be limited to the disclosed embodiments or implementations but, on the contrary, is intended to cover various modifications and equivalent arrangements included within the scope of the appended claims, which scope is to be accorded the broadest interpretation so as to encompass all such modifications and equivalent structures as is permitted under the law.

1. A tensioner for reducing vibration and noise associated with a vehicle engine, comprising:
a tensioner arm having a cylindrical protrusion extending from a first side of the tensioner arm, the cylindrical protrusion having at least one counter-bore disposed on a surface of the cylindrical protrusion and an inner bore extending through the cylindrical protrusion;
an axle adapted to be received by the inner bore, the tensioner arm being adapted to rotate about the axle;
a first spring disposed proximate to a second side of the tensioner arm and opposite to the first side of the tensioner arm, the first spring being adapted to bias the tensioner arm in a first direction; and
a damping structure, comprising:
a damping seat adapted to engage at least one portion of the axle; and
a second spring, wherein a damping characteristic of the damping structure increased in response to the second spring limiting the tensioner arm in a second direction opposite to the first direction.

2. The tensioner of claim 1, wherein the second spring includes a first end and a second end and wherein the first end is coupled to the damping seat and the second end is received by a first spring seat hole disposed on the second side of the tensioner arm.

3. The tensioner of claim 1, wherein the tensioner arm includes a self-lubricating bearing disposed in the inner bore.

4. The tensioner of claim 1, further comprising a friction pad that comprises at least one boss having a profile corresponding to a profile of the at least one counter-bore.

5. The tensioner of claim 1, further comprising a fixed bottom plate that includes a center hole adapted to receive at least a portion of the damping structure.

6. The tensioner of claim 5, wherein the first spring includes a first end and a second end, the first end is received by a second spring seat hole disposed on the second side of the tensioner arm, and the second end is received by a third spring seat hole disposed on an inner surface of the fixed bottom plate.

7. The tensioner of claim 5, wherein the axle includes a bushing compressed to the axle connecting with the fixed bottom plate.

8. The tensioner of claim 1, further comprising a pulley that includes a bearing.

9. The tensioner of claim 8, wherein the pulley is adapted to receive the bearing and wherein the bearing includes a through bore that is adapted to receive a portion of the tensioner arm.

10. A tensioner, comprising:
a tensioner arm having a protrusion extending from a first side of the tensioner arm, the protrusion having an inner bore extending through the protrusion;
an axle adapted to be received by the inner bore, the tensioner arm being adapted to rotate about the axle;
a first spring disposed on an inner portion of the tensioner arm, the first spring being adapted to bias the tensioner arm in a first direction; and
a damping structure, comprising:
a damping seat adapted to engage at least a portion of the axle; and
a second spring comprising:
a first end disposed proximate a second side of the tensioner arm; and
a second end coupled to the damping seat.

11. The tensioner of claim 10, wherein the tensioner arm includes a self-lubricating bearing disposed in the inner bore.

12. The tensioner of claim 10, further comprising a friction pad that includes at least one boss having a profile corresponding to a profile of at least one counter-bore disposed on the protrusion, wherein the at least one boss is received by the at least one counter-bore.

13. The tensioner of claim 12, further comprising:
a cover plate that includes a first pin hole disposed on an outer surface of the cover plate; and
a second pin hole disposed on an outer surface of the friction pad wherein the first pin hole is adapted to align with the second pin hole.

14. The tensioner of claim 13, further comprising an adjusting aperture disposed on the cover plate wherein the first pin hole can be adjusted to align with the second pin hole through adjusting the adjusting aperture.

15. The tensioner of claim 10, further comprising a fixed bottom plate that includes a center hole adapted to receive at least a portion of the damping structure.

16. The tensioner of claim 15, wherein the axle includes a bushing compressed to the axle connecting with the fixed bottom plate.

17. The tensioner of claim 10, further comprising a pulley that includes a bearing, wherein the bearing includes a through bore that is adapted to receive a portion of the tensioner arm.

18. A system, comprising:
a tensioner arm having a cylindrical protrusion extending from a first side of the tensioner arm, the cylindrical protrusion having at least one counter-bore disposed on a surface of the cylindrical protrusion and inner bore extending through cylindrical protrusion;
an axle adapted to be received by the inner bore, the tensioner arm being adapted to rotate about the axle;
a first spring disposed proximate a second side of the tensioner arm, opposite the first side, the first spring being adapted to bias the tensioner arm in a first direction;
a friction pad that includes at least one boss having a profile corresponding to a profile of at least one counter-bore;
a fixed bottom plate comprising:
a first spring seat hole disposed on an inner surface of the fixed bottom plate; and
a damping structure, comprising:
a damping seat adapted to engage at least a portion of the tensioner arm;
a second spring comprising:
a first end disposed proximate the second side of the tensioner arm; and
a second end coupled to the damping seat, wherein the damping structure limits rotation of the tensioner arm in a second direction opposite the first direction.

19. The system of claim 18, further comprising:
a cover plate that includes a first pin hole disposed on an outer surface of the cover plate; and
a second pin hole disposed on an outer surface of the friction pad wherein the first pin hole is adapted to align with the second pin hole.

20. The system of claim 19, further comprising an adjusting aperture disposed on the cover plate wherein the first pin hole can be adjusted to align with the second pin hole through adjusting the adjusting aperture.
